(19) United States
(12) Patent Application Publication
(10) Pub. No.: US 2013/0305446 A1
(43) Pub. Date: Nov. 21, 2013

(54) Disposable Shower Bucket and The Privacy Jacket

(71) Applicants: Shirley Smith, Fort Smith, AR (US); Jacklyn Smith Sanders, Cypress, TX (US); Dedtra Deneat Smith, Fort Smith, AR (US); Christina Smith-Massey, Fort Smith, AR (US); Justice Lugretta Smith, Fort Smith, AK (US); Micheal Smith, Fort Smith, AR (US); James Smith, SR., Fairburn, GA (US); Charleston Dakota Smith, Fort Smith, AR (US)

(72) Inventors: Shirley Smith, Fort Smith, AR (US); Jacklyn Smith Sanders, Cypress, TX (US); Dedtra Deneat Smith, Fort Smith, AR (US); Christina Smith-Massey, Fort Smith, AR (US); Justice Lugretta Smith, Fort Smith, AK (US); Micheal Smith, Fort Smith, AR (US); James Smith, SR., Fairburn, GA (US); Charleston Dakota Smith, Fort Smith, AR (US)

(21) Appl. No.: 13/474,093

(22) Filed: May 17, 2012

(51) Int. Cl. A61G 9/00

(52) U.S. Cl. 4/451

(57) ABSTRACT

The disposable shower bucket is provided as a component used to provide comfort and secure the dignity of patients in healthcare facilities. It is comprised of a soft, flexible, round molded texture that has a inner layer composed of padding sections to helps separate and absorb both feces and wastes as they are exposed of by the body. The disposable bucket is designed to be used with the Privacy Jacket (U.S. Patent No. 61/518,982) by attaching inside the back-inner portion of the garment. It can also be used with The Shower Jacket (U.S. Pat No. 61/518,983). It is to be used with a standardized shower chair, and can be worn by the patient as they are transported from location to location. It fits securely under the shower chair and aids in providing cleanliness, comfort and support, and dignity to all patients.

I claimed priority of the provisional application 61/518,981 filed on May 16, 2011, the provisional application 61/518,982 filed on May 16, 2011, and the provisional application 61/518,983 filed on May 11, 2016.

### REFERENCES CITED

U.S. Patent Documents

| | | | |
|---|---|---|---|
| 5,193,232 | 07/759/917 | March 1993 | Flood, et al |
| 4,368,548 | 06/342,285 | January 1983 | Glass |
| 5,375,270 | 08/236,461 | December 1994 | Demers, Jr., et al |
| 5,608,925 | 08/492,172 | March 1997 | Porter |
| 6,789,277 | 09/872,337 | September 2004 | Spitzer |
| 5,455,972 | 08/280,597 | October 1995 | Williams |
| 7,810,172 | 11/432,257 | October 2010 | Williams |
| 4,975,984 | 07/379,174 | December 1990 | Sting |
| 4,474,500 | 06/863/435 | July 1988 | Brucato, et al |
| 4,547,907 | 06/477,351 | October 1985 | Netsky |
| 4,370,757 | 06/359,946 | February 1983 | Richmond |
| 6,484,321 | 09/848/938 | November 2002 | Shamam |
| 6,134,715 | 09/507,911 | October 2000 | McLennan |
| 5,946,722 | 08/864,468 | September 1999 | Trautmann |
| 5,444,872 | Johnson | July 1994 | Johnson |
| 5,361,414 | 08/128,093 | November 1994 | Smith |
| 5,575,006 | 08/349/748 | November 1996 | Wolfe |
| 6,012,168 | 09/188/429 | January 2000 | Hutton, et al |
| 6,237,153 | 09/451/039 | May 2001 | Bowens |
| 6,499,143 | 09/829/663 | December 2002 | Garza |
| 7,181,773 | 11/193/190 | February 2007 | Piraka |
| 7,865,973 | 12/286/851 | January 2011 | Gibson |
| 8,069,497 | 12/319,258 | December 2011 | Sheward et al |

### Foreign Patent Documents: Not Applicable

### BACKGROUND OF THE INVENTION

I claimed priority of the provisional application 61/518,981 filed on May 16, 2011, and the provisional application 61/518,982 filed on May 16, 2011. These present inventions relate to a disposable shower bucket and a privacy jacket to be used during the activities of daily living for patients in any healthcare facility. They are a new innovation for healthcare. The disposable shower bucket will bring healthcare from a problem to a solution, a concept within patient's care. It is significant in meeting the patient's need; it can be utilized for a patient's rehabilitation and recovery needs, and is designed to be connected to the Privacy Jacket (U.S. Pat No. 61/518,982), while transporting a patient to and from the shower. This will ensures the personnel caring the patient to a more hassle and stress free experience.

The disposable shower bucket is also great for a patient who previously had a surgery, or amputation. Since these patients are unable to complete certain activities of daily living such as turning over, the disposable shower bucket gives the patient more support to complete basic anatomical movements. The disposable shower bucket is comprised of a soft, flexible bucket with a round texture. The inner layer is built to house all the patient's feces in waste in two layers. One layer controls all urine, where the urine is absorbed in a padded sector. All feces will be absorbed with layered padding, which can be doubled to apply cushion. When the inner padding becomes soiled with the patient's urine and feces can be easily removed, and replaced back with another new padding. This easy exchange provides a sense of ease and comfort to the patient. It does not take away from the special care that the healthcare worker must provide to the patient, but it does assist by being easy for the healthcare worker to be able to perform their duties efficiently. If the patient is feeling uncomfortable with the extra cushion, then it can be removed to fit the patient's desire for comfort. The disposable shower bucket can easily be removed without removing the entire bucket, which emphasizes the ease and accessibility that the disposable shower bucket gives both the patient and the patient care staff.

After years of patient care experience, seeing the use of bedpans in patient care facilities have made the jobs a lot harder for healthcare workers. Most patients after surgery have a hard time using the bedpan and constantly complain about the irritability that the bedpan gives their skin. Some of the patients in healthcare facilities are fragile, underweight, bedridden, have decubitis ulcers, or a combination of the above and other conditions that require them to use the bedpan. Some may also complain about the pain of the bedpan underneath them, and limited movements they are able to perform, due to having to use the bedpans used in the healthcare facilities today. The current bedpans on the market today are not only stressful and a hassle for the patients, but also to the healthcare workers that care for them. The current bedpans do not allow the workers to successfully clean the patient properly and respectively at the same time. Since the bedpan makes it more difficult to clean the patient, the healthcare worker must spend longer times cleaning. There are combinations of scenarios the worker may experience like: spillage while trying to get the bedpan from underneath the patient, the risk of sanitation, or the risk of exposure resulting in loss of dignity for the patient. This can make the job of the worker harder.

Therefore, the disposable shower bucket will allow the workers to clean the patient properly and carefully without it being time consuming or a hassle. It provides ease of cleanliness by allowing the healthcare worker to change out the pads to maintain dryness and cleanliness based on the patient's needs, and it provides a since of dignity and comfort for the patient.

The present invention relates to a garment that can be used in any healthcare facility. It is very comfortable and unique. The privacy jacket is designed for total coverage on the body. The shoulders are round and smooth; the neckline has a wide opening which is great for a patient who may have a crate. The privacy jacket consists of a medium pocket with a small opening through the pocket that is great for oxygen tubes. It has medium-sized pockets on both sides to of the jacket. It flows down the torso, slightly passed the knees to ensure the privacy of the patient. The privacy jacket goes on through the right side of the body and closes on the left with two sections of three snaps to make it less time consuming. The privacy jacket contains a back pocket with a small center snap that connects to the back inside of the privacy jacket. This back pocket allows the healthcare workers to utilize the disposable bucket to their advantage. The disposable bucket is designed to snap, and fold inside the back inside pocket of the privacy jacket.

Patients are now using hospital gowns with an opening in the back and three ties that expose the body of the patient. The hospital gowns are composed of a thin material, and in some cases, a patient must use two hospital gowns to properly cover their body for privacy. These gowns are insufficient to wear around the hospitals, which cause patients to have to add extra gowns or padding to risk not being exposed. The hospital gown also does not efficiently allow the patient to carry their everyday necessities in them like the privacy jacket does. The privacy jacket is hypoallergenic, and creates more freedom to the patient while still giving the patient the privacy they deserve. The privacy jacket is designed to be hassle-free as it provides privacy, flexibility, and comfort while maintaining the dignity of all patients. There are several different garments used today that are configured to provide privacy to patients. Gowns used in the hospital or nursing home facilities today are generally open-back style, and provide some but not total control of privacy for patients. Also these gowns cannot be easily used outside the hospital corridors. Patients need to feel warm and comfortable in their gowns as they await assistance from patient care personnel. Patients must change their clothes and change into the garment used at the facility they are entering. By changing into gowns that have an open-back style, patients may not feel comfortable, and the material is usually rather thin, which does not provide enough privacy or warmth to the patient. By combining the disposable shower bucket with the privacy bucket a patient is better able to have comfort and support, and maintain a sense of dignity due to the privacy jacket and the shower bucket. There are various other products on the market that are similar to both the disposable shower bucket and the privacy jacket, because they have more than one part to help provide privacy to the patient, and others that are designed to aid in the disposal of patient feces and waste, and to make the jobs easier for personnel of healthcare facilities. Some examples are seen in the following U.S. patents:

Flood, et al. U.S. Pat. No. 5,193,232, illustrates the use of a collapsible bed pan support or pad for bed-ridden persons. The pad has a U-shaped opening provided with a pair of camming; catch members for retaining a bedpan in place. The U-shaped opening is reinforced along its annular wall to prevent buldging, in order to better retain the bedpan in the U-shaped opening of the pad. A bottom apron is provided to protect bed sheets while the bedpan is being used. A specially designed bedpan cooperates with the camming members of the pad to retain the bedpan in place.

Glass, U.S. Pat. No. 4,368,548 displays a nestable undercut bedpan. It shows an injection-molded nestable bedpan having a cavity defining a receptacle formed by a bottom wall and a tapered upright wall, and a seat formed at the upper edge of said upright wall. The tapered upright wall includes opposed sidewall segments and opposed end wall segments with one of the tapered end wall segments defining an undercut to inhibit splash back and spillage.

Porter, U.S. Pat. No. 5,608,925 illustrates a wheelchair with bedpan, where a wheel chair seat is formed with an aperture around which a toilet seat and lid are mounted. A bedpan support and removable bedpan are positioned directly below the aperture. The bedpan may be easily installed and removed from the support from the rear of the wheel chair seat without disturbing the occupant of the wheelchair.

Spitzer, U.S. Pat. No. 6,789,277 shows a display according to a present invention, where an apparatus for collecting, disposing, and measuring liquids including a vessel with an inner surface and an absorption mechanism disposed on the inner surface of the vessel for absorbing and collecting liquids within the vessel. The present invention additionally provides for an absorption mechanism disposed on an inner surface of a vessel for preventing the spillage of any liquids, particularly those associated with excretory waste. Finally, the present invention provides for a method of using the apparatus claimed herein to collect, dispose, and measure liquid output from a bedridden individual.

Williams. U.S. Pat. No. 5,455,972 illustrates a disposable bedpan and method of using. It shows a bag constructed from synthetic plastic material that is impervious to liquid and other human waste has a pouch bonded to an exterior surface. The pouch has a wall remote from the surface of the bag, which is constructed from a material, which may be permeated by liquid. Liquid absorbing crystals are disposed between the wall and the surface of the bag. A bedpan may be positioned within the bag and the pouch pushed into the well of the bedpan. Human waste may be deposited onto the surface of the bag and the pouch in conventional manner, and thereafter the bag is turned inside out as it is removed from the bedpan so that the waste remains within the interior of the inverted bag. The entry to the bag may thereafter be tied closed. The bedpan thus remains free of contact with the waste and need not be cleaned.

Demers, Jr., et al. U.S. Pat. No. 5,375,270 displays a bedpan washing guard with anti-splash back feature. This device is illustrated as a washing guard for a bed pan provides a means for deflecting splash back and aerosolized particulates from readily passing onto health care workers and/or other patients thereby exposing them to a potential hazard and/or contamination by the particulates and/or splashed effluent coming to rest or splashing onto the worker. The washing guard is further provided with a means for allowing it to be readily attached to a bed pan and includes a means for grasping and holding it in a vertical oriented orientation such that the health care worker is free to use his or her free hand to wash the bed pan with a spray jet while assembled to the washing guard.

For the use of privacy, Shamam, U.S. Pat. No. 6,484,321, and Johnson, U.S. Pat. No. 5,444,872 displays the use of a multi-purpose patient hospital gown. The invention relates to a closed rear gown for a patient to wear in the hospital that provides for modesty and for convenient access to the patient's body by the medical and nursing staffs, for patient care. The gown is provided with a front opening and closing by the patient and for opening and closing the sleeves at the top of the shoulder to provide for access to the shoulder, arms and back of the patient by the medical and nursing staff.

A telemetry pocket may also be provided. Johnson's designed hospital-type gown wherein comfort, style and cost savings in manufacture are provided, yet still enabling the patient wearer to preserve modesty while providing necessary access to the patient by a doctor or nurse for either examination or treatment.

Trautmann, U.S. Pat. No. 5,946,722 illustrates a patient's privacy gown displaying more particularly a patient privacy gown wherein the front has a slit opening beginning below the neckline and terminating above the hemline. The slit opening allows the patient to maintain modesty while allowing the doctor access to the patient's torso.

Sting, U.S. Pat. No. 4,975,984 displays a one-piece garment where the garment has two panels with a neck opening between the panels. The second panel has a central panel, side panels and transverse panels. The central panel covers the wearer's back and shoulders, the side panels cover the wearer's sides from under the junctions of the wearer's arms and shoulders, and the transverse panels extend substantially across the wearer's chest. The first panel may lie over or under the transverse panels. Means for closing the transverse panels is provided so that the transverse panels may be secured in position across the wearer's chest. In a preferred embodiment, the closure means allows the transverse panels to be closed in two ways: first, with one transverse panel overlying the other; second, in a draw string manner with the outer ends of the transverse panels extending toward each other. The panels of the garment are proportioned to ensure adequate coverage of the wearer.

McLennan, U.S. Pat. No. 6,134,715 illustrates a medical patient gown which is formed from a single section of a soft fabric material that is suitable for patient wear in a doctor's office or hospital to cover over a patient's body and is selected to have a pleasing pattern and/or print to be aesthetically pleasing to the patient wearing the garment. The gown can be worn forward or backward, includes wide sleeves, is of a size to be wrapped around the patient's body and closed, and includes easily and conveniently releasable fasteners to secure the wrap around the patient's body that are easily opened to allow access by medical personnel performing a procedure on a section of the patient's body.

Williams, U.S. Pat. No. 7,810,172 illustrates a garment for accommodating medical devices. It is comprised of a garment panel detachably coupled to a garment body. The garment panel contains a concealed pocket suitable for accommodating one or more medical devices. The garment panel is detachable from the garment body at predetermined attachment zones, which provide access to device sites and permit complete detachment of the garment panel. The panel may also be fixed to the garment body at anchor zones, while allowing decoupling at attachment zones. The pocket may contain an inner compartment for receiving a supplemental material such as an absorbing or deodorizing material. Apertures to the inner compartment allow the supplemental material to proximate device sites on the patient body or medical apparatus stored in the pocket. Stabilizers positioned on the interior of the garment may be used to secure medical monitor wires, tubing, or other devices. This garment is intended for wear by both children and adults.

Richmond, U.S. Pat. No. 4,370,757 displays a design for patients in hospitals or nursing homes. It comprises first and second garment portions which have upper and lower ends and inner and outer side edges. The first and second garment portions are joined at their upper inner side edges to form a body portion which may be wrapped around the person to cover the lower abdomen, thighs and buttocks of the person. The lower ends of the first and second garment portions have ankle receiving portions adapted to receive the ankles of the person. The garment portions have a width sufficient, between the body portion and the ankle receiving portions, to enable the first and second garment portions to be wrapped around the person's legs. A foldable modesty panel is provided at the juncture of the upper inner side edges of the garment portions. The modesty panel extends downwardly from the body portion and covers the person's genital area whether the person is standing, sitting or reclining

Brucato, et al., U.S. Pat. No. 4,754,500 illustrates special garments used for disabled and infirm by providing a front and back portion to enclose a portion of a person wherein the front is comprised of an inner front portion and a removable outer front portion. The inner front portion of the garment includes an outer face of a selected design and material having a fastening means disposed about a selected area thereon. The outer front portion comprises an outer face of design and material matched with the selected design and material of the outer face of the inner front portion and an inner face which is fluid resistant and includes a fastening means about an area matched with the selected area of the inner front portion, designed to align and cooperate with the first fastening means to release and attach together the outer face of the inner front portion and the inner face of the outer front portion forming a removable bib-like portion which matches the garment portion. The garment also is divided along a split in its vertical height into two back portions, each including cooperating releasable fastening means to enable the user to secure together and separate the two back portions. The garment is particularly beneficial to incontinent individuals and individuals susceptible to drooling or having feeding problems.

Gordon, U.S. Pat. No. 4,964,173, which illustrates that it has minimal parts, and a fully closed back portion as well as overlapping lower front portion that is capable of being detached temporarily via fastening means devoid any snap fasteners, which are subject to being released or opened for limited access to upper body areas and/or lower body areas as necessary as opposed to whole body exposure.

Gibson, U.S. Pat. No. 7,865,973 displays a self-contained, expandable hospital gown having a central retainment belt from which expandable adjustable upper and lower gown portions can be selectively deployed. Engagement and interlocking tabs provide deployment on the upper torso, extending portion and lower torso extending portion with independent retainment and positioning access openings associated therewith.

Sheward et al, U.S. Pat. No. 8,069,497 presents hospital gowns with specific pockets, slits, to allow mounting catheter bag concealed inside gown of patient for maximum mobility and privacy with various monitors, caterers and lumens attached, passing through openings in gown to reach the patients body and closures that are simple to use and provide for patient privacy with approximately 125% wrap around.

Smith, U.S. Pat. No. 5,361,414,Wolfe, U.S. Pat. No. 5,575,006, Hutton, U.S. Pat. No. 6,012,168, Bowens, U.S. Pat. No. 6,237,153, Garza, U.S. Pat. No. 6,499,143, Piraka, U.S. Pat. No. 7,181,773, Netsky, U.S. Pat. No. 4,547,907 displays a privacy gowns consisting of a body garment having a front portion, a vertically split rear portion divided into two segments, a pair of sleeves and a neck opening, so that the body garment can be worn by the patient. It has a fastener to retain the two segments of the vertically split rear portion together at the neck opening. It has a structure for covering up a lower separation of the two segments of the body garment at the waste to provide modesty, and to be quickly opened for examination and access to the body. The garments allow for medical equipment to be easily accessed. These garments also provide privacy separately over the patient's body versus providing a one-piece covering, with access to the body for examinations and medical equipment. One allow for warmth from cold drafts, while allow the body to be easily accessed.

### SUMMARY OF THE INVENTION

It is therefore an object of the present inventions to provide a disposable shower bucket and the privacy bucket. The disposable shower bucket is a component with a minimum number of parts, composed of a soft, flexible, and round texture, with an inner padded chamber to catch all feces and wastes that are exposing from the body. It is designed to snap into the back of the Privacy Jacket (U.S. Patent No. 61/518,982), fold out, and then be applied underneath any standardized shower chair. It is then strapped across the lap of the patient to provide security as the patient is transported. Strapping the across the patient's lap secures the bucket in place. The molded pattern of the bucket is designed to prevent spillage and provide both cleanliness and dryness as the patient is transported. The inner part of the bucket is designed to be padded to catch both feces and urine, which can be changed depending on the needs of the patient.

Another object of the invention is that the disposable shower bucket is designed to be housed on the backside of the Privacy Jacket (U.S. Patent No. 61/518,982). The Privacy Jacket has basically like an upside down pocket in the back designed with a center snap button for the disposable shower bucket to attach to and hold the disposable shower bucket. Once secure, the strap then is placed under the shower chair. There are two more straps that come out and across the lap of the patient and snap close either with a button or Velcro. The disposable shower bucket can also be used by itself. This provides comfort and security while the patient is being transported. These objects of the invention will provide the patient and workers with ease and accessibility, comfort and support while providing a sense of pride and dignity to the patients.

### BRIEF DESCRIPTION OF THE DRAWINGS

The invention will more fully be understood and apparent in the following detailed descriptions and illustrations in the accompanying drawings in which:

FIG. 1; Page 1—The disposable shower bucket, FIG. 1: is a full view of the bucket. It shows the belt closure on the top (1), and where they connect on the bottom (2). There is a display of the elastic that resembles an inner lining of elastic band which helps to hold the bucket in place (3).

FIG. 2—displays a full-size top view of the bucket on the inside being the same at the bottom (1), the padding on the upper layers and bottom layers of the bucket (2-14).

FIG. 3—shows the diameter of the inside of the bucket which is 6 inches.

FIG. 4—displays the thickness of the pads to be 3/16 inches in diameter and 2 inches in thickness.

FIG. 1; Page 2—The privacy jacket: FIG. 1 displays the entire privacy jacket on the body. It displays the neck opening (1), the arm openings (2), the buttons that snap down the side of the garment (3), the large pocket in the back, designed to tuck and hold the disposable shower bucket (4), the pockets (5), and the large pocket in front to hold necessity items (6).

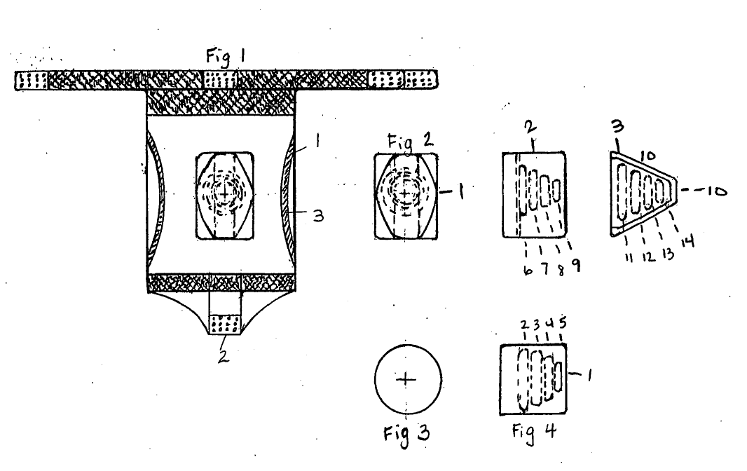

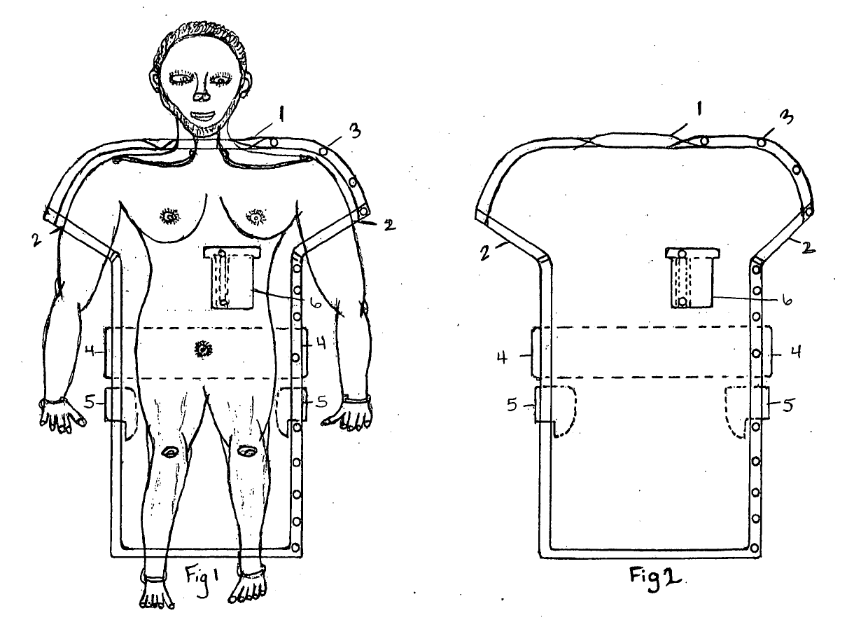

FIG. 2;—displays the privacy jacket, front view, off of the body with the corresponding numbers for its parts. The neck opening (1), arm opening (2), the buttons (3), the large pocket in the back (4), the pocket opening (5), and the larger front pocket for necessity items (6).

### DETAILED DESCRIPTION OF THE INVENTION

The disposable shower bucket is presented as a new innovation for healthcare. It is designed to replace the use of all bedpans currently being used in the healthcare facilities. It is designed to provide more cleanliness and comfort to patients who have may need bedpans to assist with their activities of daily living. The disposable bucket is made of a flexible, soft, and molded material designed to catch all the feces and wastes exposed of by the body. Currently patients have to use very hard pans that catch and mix all the feces and waste in it, but is difficult to get under and out from the patient. The disposable bucket is designed to catch the urine at one level (bottom), and the feces at another level (top) using disposable padding. The padding can be adjusted based on the patient's needs. This will keep the patients clean and dry during the day and night. Healthcare workers will experience such ease with cleaning and comforting patients. Most patients are bedridden, have pressure sores, decubitis ulcers, and are very fragile and underweight. Having to put the current large pans under these particular patients can hurt them and make them sore. It also limits their ability to turn and rotate in the bed. Since the disposable shower bucket is disposable, healthcare workers do not have to try to clean these buckets. They can simply change the padding according to the patient's needs or dispose of the bucket and get a new one.

The shower disposable shower bucket is also made to be attached onto the inside of the Privacy Jacket (U.S. Pat No. 61/518,982), or to be worn with The Shower Jacket (U.S. Pat No. 61/518,983). This makes it easier for patients who are using any of these two garments, and may need to be transported to different locations. Both the shower jacket and the privacy jacket provide comfort, a sense of dignity and pride to the patient when they are be cared for, and transported. With the disposable bucket the patients are able to feel clean and comfortable and not risk being exposed all at the same time.

1. What is claimed is that the disposable shower bucket is designed to provide more effective cleanliness and comfort to all patients in the nursing home or healthcare facility by providing an alternative to the use of the bedpan in all healthcare facilities. It allows the patients to have more comfort and support as they access activities of daily living. It provides a sense of pride and dignity to the patients.

2. As claimed in claim 1, the disposable shower bucket is designed to provide cleanliness. Therefore the use of pads can be quickly changed in and out to provide cleanliness and comfort.

3. As claimed in claim 1, the disposable shower bucket is designed to assist with the activities of daily living by allowing more flexibility to the patient's body being comprised of a soft, flexible, molded material, instead of the hard bedpans used currently.

4. The disposable shower bucket is designed to be used alone or with the Privacy Jacket (U.S. Patent No. 61/518,982) by attaching on the inside lower-back portion, inside (invisible to the outside) pocket of the Privacy Jacket. Its location also provides more cushion and privacy to the backside of the patients as they wear the gown. The disposable shower bucket can be worn in conjunction with The Shower Jacket (U.S. Pat No. 61/518,983).

5. As claimed in claim in 2, the disposable shower bucket is designed to be worn by anyone, and to different locations the patient needs to be transported to, to help provide protection to the patient.

6. As claimed in claim in claim 2, the disposable shower bucket can be used with the disposable shower jacket and the privacy jacket or separate.

7. The disposable shower bucket is designed to be hassle free and easy to use for healthcare workers. Healthcare workers no longer have to worry about spilling the patient's waste, neither violating privacy laws, nor ridding patients of their dignity due to having to use bedpans that inhibit the access to total activities of daily living.
